(19) United States
(12) Patent Application Publication
(10) Pub. No.: US 2013/0265565 A1
(43) Pub. Date: Oct. 10, 2013

(54) COAL ANALYSIS SYSTEM

(71) Applicant: PROGRESSION, INC., Haverhill, MA (US)

(72) Inventors: Vaughn E. Davis, York, ME (US); Daniel J. Curtis, Spring Hill, FL (US)

(73) Assignee: Progression, Inc., Haverhill, MA (US)

(21) Appl. No.: 13/858,557

(22) Filed: Apr. 8, 2013

Related U.S. Application Data
(60) Provisional application No. 61/686,617, filed on Apr. 9, 2012.

(51) Int. Cl. G01N 21/71

(52) U.S. Cl. CPC G01N 21/718
USPC 356/36

(57) ABSTRACT

A coal analysis system and method includes an extrusion subsystem configured to produce an extrusion from coal samples. An auger drives coal samples through a centering ring producing the extrusion. A LIBS subsystem is configured to analyze the extrusion and an NMR analysis subsystem is downstream of the LIBS subsystem to further analyze the coal.

### RELATED APPLICATIONS

This application claims benefit of and priority to U.S. Provisional Application Ser. No. 61/686,617 filed Apr. 9, 2012 under 35 U.S.C. §§119, 120, 363, 365, and 37 C.F.R. §1.55 and §1.78 and is incorporated herein by this reference.

### FIELD OF THE INVENTION

The invention relates to a coal analysis system.

### BACKGROUND OF THE INVENTION

Coal is analyzed using a variety of technologies at mining operations, coke plants, and power generation plants. Ash content, moisture, and the like are typically the parameters the various coal industries desire. In one example, a laser induced breakdown spectroscopy (LIBS) type coal analysis system uses a plurality of lasers and spectroscopic detectors for analyzing coal on a conveyer belt. See U.S. Pat. Nos. 6,545,240 and 6,771,368 incorporated herein by this reference. Other coal analysis systems use nuclear magnetic resonance type analysis systems. See U.S. Pat. Nos. 5,015,954; 5,530,350; and 5,049,819 incorporated herein by this reference.

Coal particles or powder, however, can be extremely difficult to work with especially in conjunction with sophisticated high tech analysis equipment. Dust is always a concern. Varying size pieces of coal having different surface characteristics and the like can affect the accuracy of an analysis. Some current operations are batch fed in that some type of sampling system brings a coal sample to an NMR analyzer. A different sample is then presented to a LIBS analyzer.

### SUMMARY OF THE INVENTION

In accordance with various aspects of the invention, an improved coal analysis system, in one example, is provided wherein the analysis equipment is in line and configured to continually analyze a more stable and continuous rod-like extrusion or extrudate or billet of coal. The system is designed to assist coal mining operations, coal fired generating stations, and other industrial coal and coke users. Economic operations are improved, greenhouse gas emissions are reduced, risk management is improved, and there is the ability to verify custodial transfers.

The preferred system is preferably designed to measure moisture content through NMR spectroscopy. Total carbon content, sulfur, total ash content, and ash constituents are analyzed through a LIBS subsystem. Energy content can be measured using a combination of LIBS and NMR. The analyzer is designed to operate in dusty and hazardous environments such as coal fired generating stations and mining operations. The fairly small foot print of the system allows it to be installed in different locations within the facility while still allowing the use of optimal statistical sampling and analysis. The flexibility of the system with regard to installation reduces engineering costs and allows the system to be installed where it will provide the most benefit to the end user.

A coal analysis system includes a sampling subsystem configured to retrieve coal samples from a feed such as a conveyor belt or pneumatic transfer line and an extrusion (extruder) subsystem receiving coal samples from the sampling subsystem and producing a rod-like extrusion from the coal samples. A nuclear magnetic resonance subsystem may be configured to analyze the extrusion and a laser induced breakdown spectroscopy subsystem may be configured to analyze the extrusion.

Preferably, the nuclear magnetic resonance subsystem and laser induced breakdown spectroscopy system are in-line with each other and the extrusion subsubsystem. The extrusion is fed from the extrusion subsystem to the nuclear magnetic resonance subsystem and the laser induced breakdown spectroscopy subsystem. There maybe a passage for the extrusion from the extrusion subsystem through the nuclear magnetic resonance subsystem and from the nuclear magnetic resonance subsystem to and through the laser induced breakdown spectroscopy subsystem. Further included may be one or more devices centering the extrusion in the passage such as a conduit insert cradling the extrusion or spaced spring feeder tabs extending within the passage.

A coal analysis system comprises an extrusion subsystem configured to produce an extrusion from coal samples and a spectroscopy subsystem configured to analyze the extrusion. In one example, the extrusion subsystem includes a centering ring and an auger for delivering coal samples through the centering ring producing the extrusion. The extrusion subsystem may further include a sleeve in the spectroscopy subsystem configured to guide the extrusion. In one design, the sleeve and the centering ring have the same inner diameter. The sleeve may have a cutout for analyzing the extrusion. The sleeve may extend at least partially within a conduit and terminate in the conduit. Preferably, the conduit has a larger inner diameter than the sleeve the sleeve terminates in the conduit proximate an analysis location, e.g., just after the analysis location.

The extrusion subsystem may be configured to produce an extrusion without the use of a binder, the spectroscopy subsystem may include a LIBS analyzer, and the coal analysis system may further include an NMR analysis subsystem.

The NMR analysis subsystem may be configured to analyze the extrusion of coal particles after the extrusion is broken up. In one design, the NMR analysis subsystem and the spectroscopy subsystem are in-line with each other and the extrusion subsystem and the extrusion is fed from the extrusion subsystem to the spectroscopy subsystem and then to the NMR analysis subsystem. In one design, the NMR subsystem is downstream of the spectroscopy subsystem. An auger may feed the coal samples to the NMR subsystem. A member may be positioned to break up the extrusion after analysis by the spectroscopy subsystem. There may be a valve between the auger and the NMR subsystem for metering the amount of coal sample delivered to the NMR subsystem. An auger may feed coal samples from the NMR subsystem. There may be a coal sample by-pass around the NMR subsystem.

Also featured is a coal analysis system an extrusion subsystem configured to produce an extrusion from coal samples wherein the extrusion subsystem includes a centering ring and an auger for driving coal samples through the centering ring producing the extrusion. A LIBS subsystem is configured to analyze the extrusion and an NMR analysis subsystem may be included.

A coal analysis method includes producing and extrusion from coal samples and using spectroscopy to analyze the extrusion. An auger may drive a coal sample through a centering ring to produce the extrusion. The extrusion may be guided in a sleeve within the spectroscopy subsystem. Preferably, no binder is used to produce the extrusion. The spectroscopy subsystem may include a LIBS analyzer configured to produce a plasma from the extruded material. The method may further include analyzing the extrusion using a nuclear magnetic resonance subsystem in line with a spectroscopy subsystem and the extrusion subsystem. In one example, the NMR subsystem is downstream of the spectroscopy subsystem.

The method may further include breaking up the extrusion after analysis by the spectroscopy subsystem, metering the amount of coal sample delivered to the NMR analysis subsystem, and/or bypassing the NMR analysis subsystem.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional partial cutaway view showing an example of a coal analysis system in accordance with the invention;

FIG. 2 is a schematic partial view of an extrusion transport passage including an insert for cradling and centering an extrusion traveling in the passage of a conduit;

FIG. 3 is a schematic view showing another example of a centering device associated with a conduit passage for transporting a coal extrusion in accordance with an example of the invention;

FIG. 4 is a schematic cross sectional view of the conduit shown in FIG. 3;

FIG. 5 is a schematic three dimensional side view of another coal analysis system in accordance with the invention;

FIG. 6 is a schematic three dimensional partially cut away view showing a portion of the coal analysis system of FIG. 5;

FIG. 7 is a schematic three dimensional front view of the centering ring shown in FIG. 6;

FIG. 8 is a schematic cross sectional side view of the centering ring shown in FIG. 7;

FIG. 9 is a schematic three dimensional view of the sleeve shown in FIG. 6;

FIG. 10 is a schematic three dimensional front view of an extruder transition ring shown in FIG. 6;

FIG. 11 is a schematic three dimensional front view of the wall adapter shown in

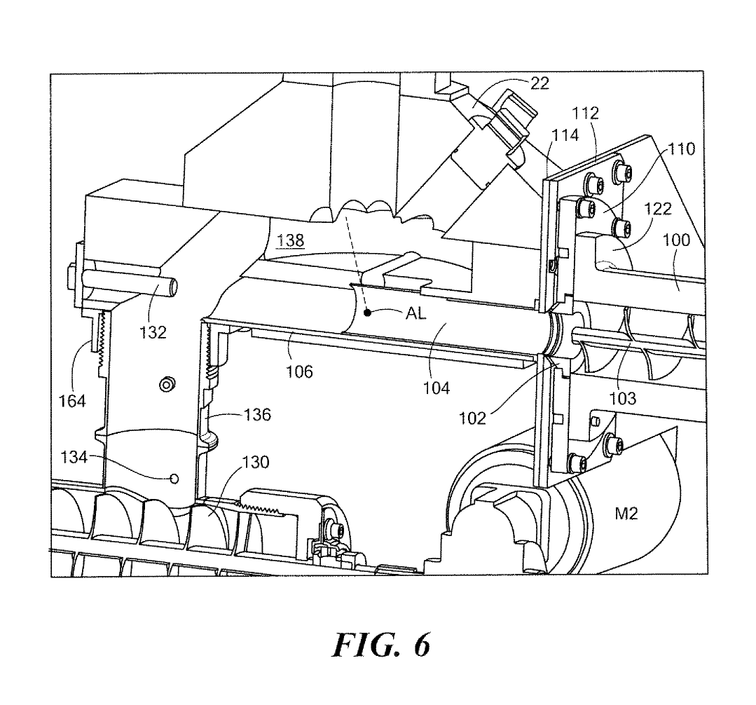

FIG. 6;

FIG. 12 is a schematic three dimensional view of a 2 inch die adapter plate used in accordance with examples of the invention; and

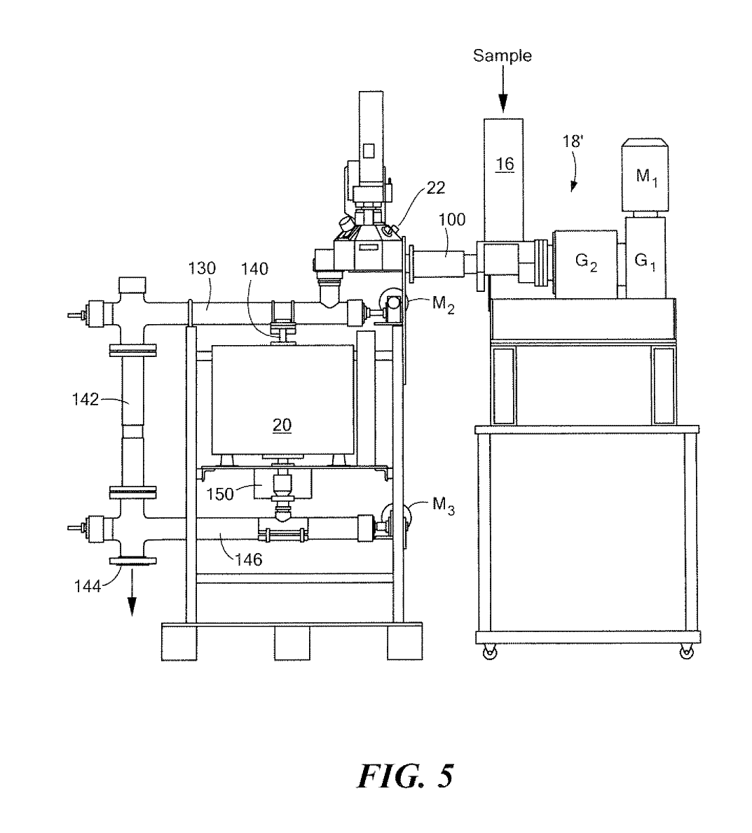

FIG. 13 is a schematic three dimensional side view of a LIBS analyzer as depicted in FIGS. 5 and 6.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

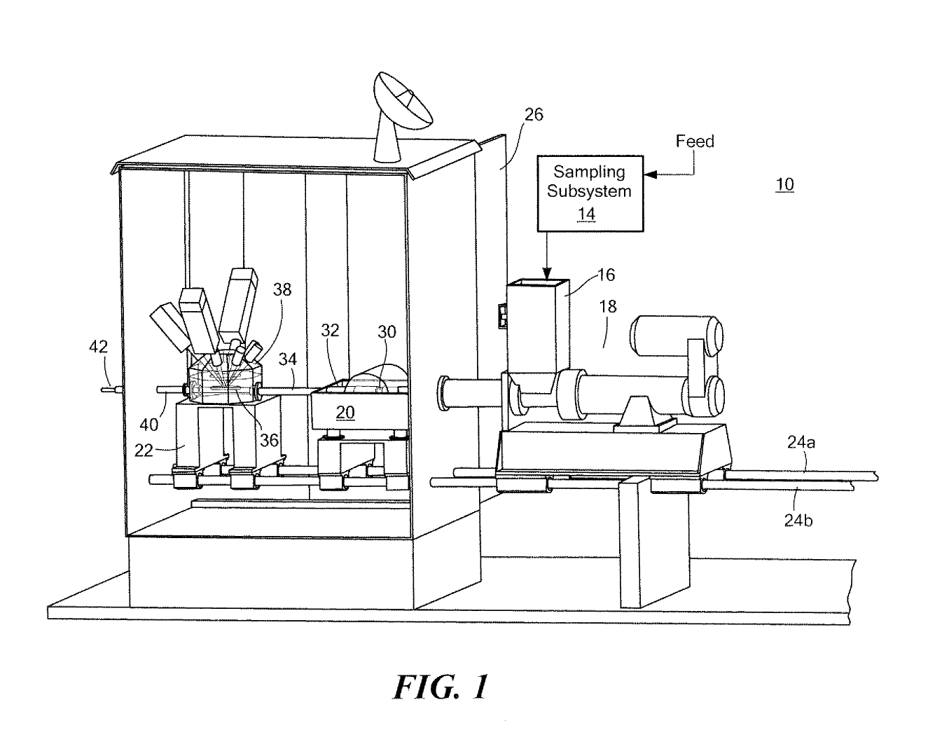

In the example of FIG. 1, analysis system 10 includes sampling system 14 which transports a sample of coal from a sample feed conveyor or the like to hopper 16 of extruder 18. Extrusion subsystem 18 receives the ground material from sampling subsystem 14 and produces a round lengthy extrusion. In one example, the extrusion was between 0.6 and 1.375 inches in diameter, and had a specific gravity of between 0.6-1.2. The extrusion allows for a continuous analysis process and provides a more stable and consistent surface for spectroanalysis (e.g., LIBS analysis and the like). The compressed extrusion is also easy to handle and reduces the amount of dust present in the system. A more homogeneous uniform sample is presented to the various analysis equipment. Lignite coal, sub-bituminous coal, bituminous coal, anthracite coal, and the like can be sampled, extruded, and analyzed.

In the particular example shown here, the extrusion proceeds through NMR subsystem 20 and LIBS analysis subsystem 22 both mounted on rails 24a and 24b with extruder 18 and housed in cabinet 26. In this way, the extruder, NMR subsystem 20, and LIBS subsystem 22 are in-line and aligned at all times.

One or more conduits typically form a passage for the coal extrusion from the extrusion subsystem 18 through NMR subsystem 20 and LIBS subsystem 22. As shown at 30, there is an NMR coil around transport conduit 32 for NMR analysis of the extrusion and conduit 34 provides a passage for the coal extrusion as shown at 36 into chamber 38 (typically filled with an inert gas) where at least a portion of extrusion 36 is exposed and analyzed by one or more lasers of LIBS subsystem 22. Conduit 40 transports extrusion 42 either back to the feed line or to a waste stream, as desired.

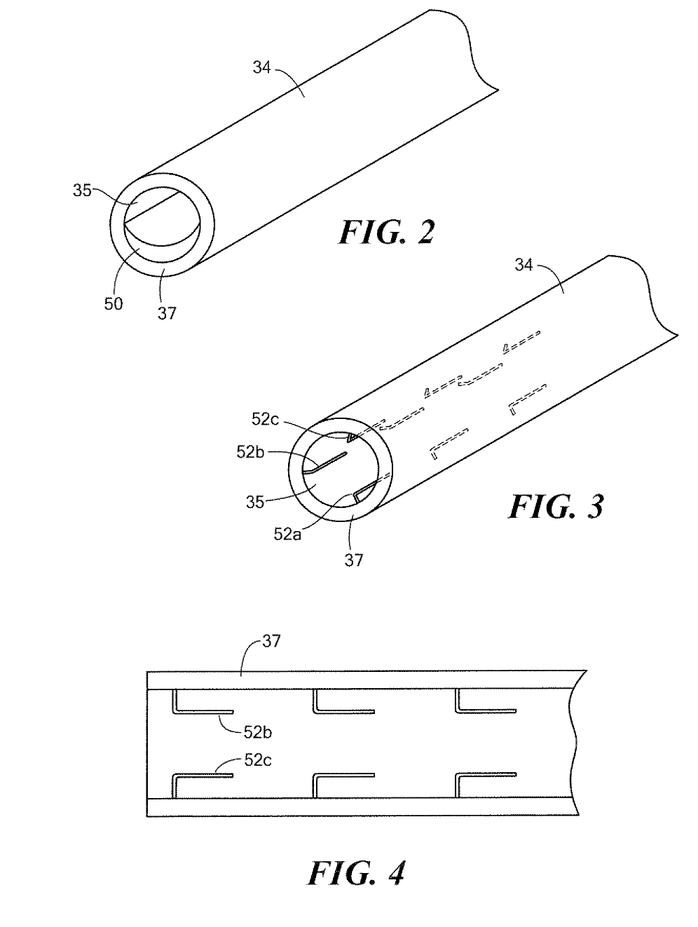

One or more of system conduits 34, FIG. 2 may include devices centering the extrusion in the passage 35 of the conduit such as insert 50 cradling the round extrusion in a centered manner within passage 35 especially for NMR analysis. If conduit 34 is made too small, the extrusion may bind as it travels in the conduit.

Conduit 34, FIG. 3 includes spaced spring feeder tabs 52a, 52b, and 52c extending within passage 35 and configured to center an extrusion therein. FIG. 4 shows how these typically spring steel feeder tabs extend inwardly from conduit wall 37 and then extend in a spaced relationship with respect to the inside of the conduit wall for some distance. Additional tabs in a repeating pattern may be provided in order to support the coal extrusion along the extent of its travel through the system. Typically, the interior of conduit 34 is 1.75 inches so the extrusion does not bind in the conduit.

If the coal mercury content or other element content is of interest to a system user, the LIBS subsystem may further include a laser tuned to the wavelength of mercury or other element. The laser is configured and oriented to intercept the plasma plume produced by the other LIBS laser(s). A photomultiplier tube that is tuned to analyze for the fluoresced mercury or other element is also provided. Note rails 24a and 24b keep other components of the system optically aligned.

In another design, the coal analysis system includes NMR subsystem 20, FIG. 5 downstream of LIBS analysis subsystem 22, or another spectroscopy subsystem such as an XRF subsystem and/or an NM subsystem.

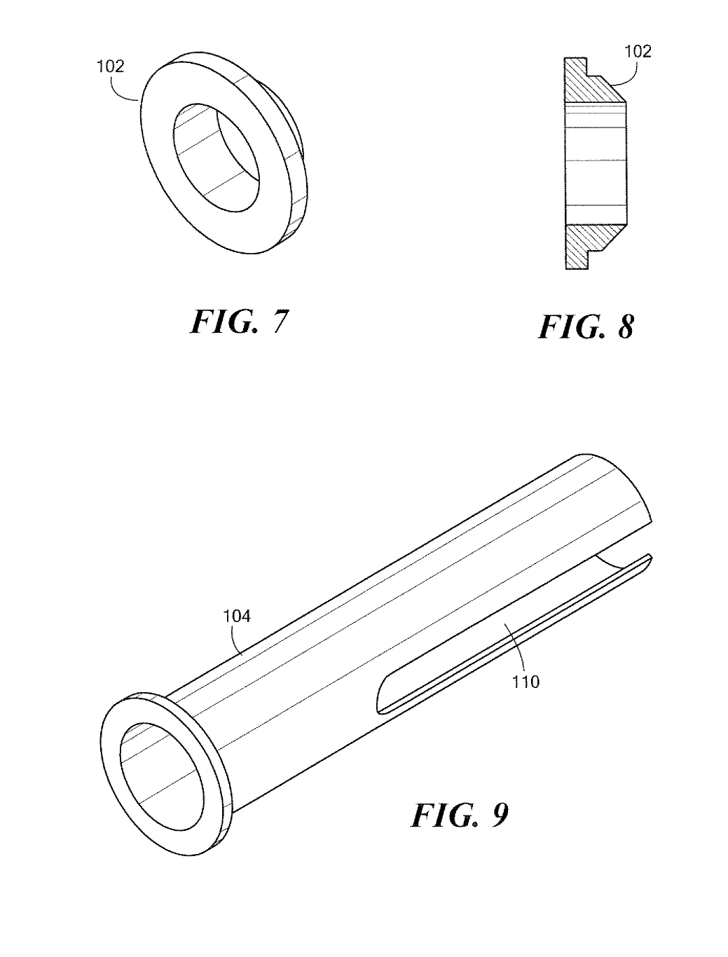

Here, extrusions subsystem 18′ includes auger 103 in 2 inch inner diameter conduit 100, FIG. 5-6 receiving ground coal from hopper 16 and driving the ground coal through centering ring 102, FIG. 6 with a 1⅜ inch inner diameter producing an extrusion within 1⅜ inch inner diameter sleeve 104, itself within 1½ inch inner diameter conduit 106 extending through LIBS subsystem 22. Motor M₁ drives auger 103 and gear boxes G₁ and G₂. Sleeve 104 guides the extrusion and may be made of a polymer material such as Delrin. Centering ring 102, FIGS. 7-8, may be made of ultrahigh molecular weight polyethylene material.

Sleeve 104, FIG. 9 has a cutout 110 allowing laser energy to reach the extrusion and for photons from the resulting plasma to reach the detector(s)/analyzer(s) of the LIBS subsystem. In one example, a spectroanalyzer is used. In cases where outer conduit 106 surrounds sleeve 104, there is also a corresponding top cutout or orifice within outer conduit 106. In other examples, conduit 106 does not extend over sleeve 104 in the area of analysis location AL. In FIG. 6, the laser energy creates a plasma at analysis location AL and sleeve 104 terminates just after location AL creating a pressure relief for the extrusion subsystem as conduit 106 has an inner diameter greater than the inner diameter of sleeve 104. Thus, the extrusion is preferably produced without the addition of any binder which could affect the analysis of the extrusion.

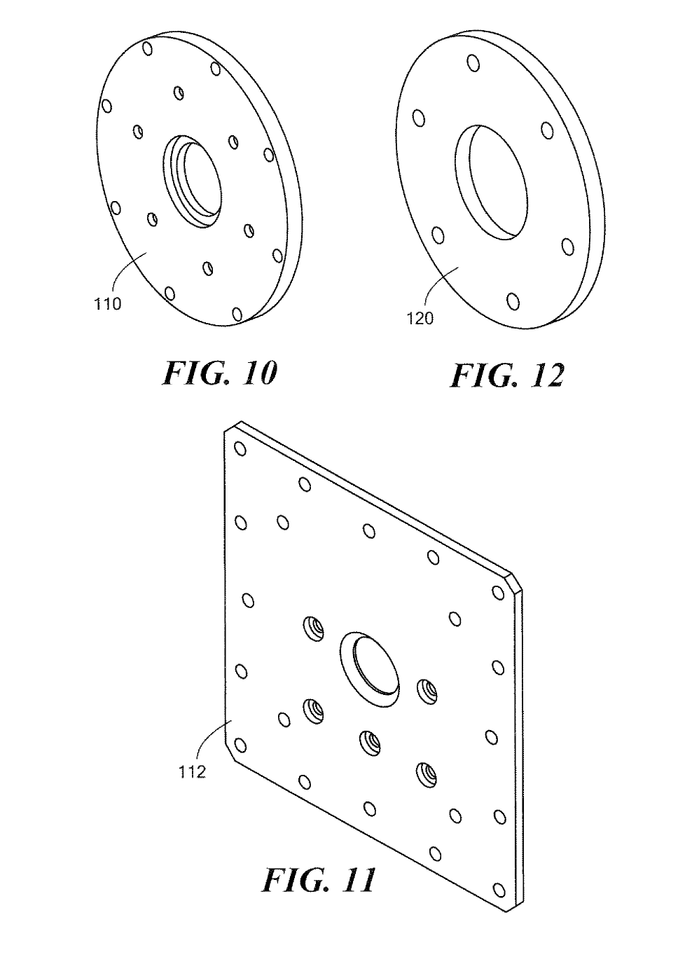

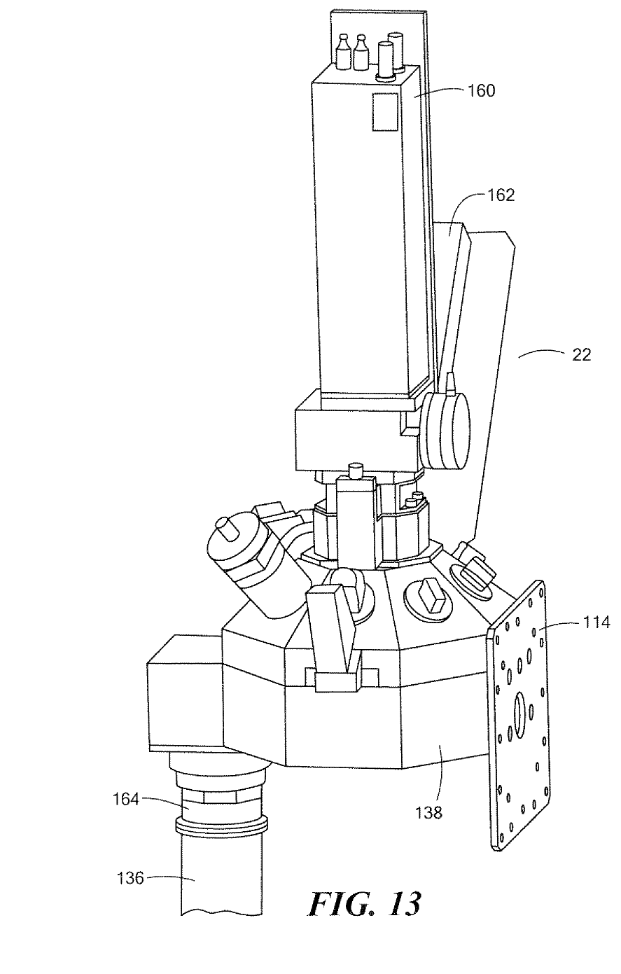

Other features include ½ inch thick transition ring 110 (see also FIG. 10) which enters centering ring 102 adjacent LIBS analyzer wall adapter 112 (see FIG. 11) between analyzer wall 114 and spacer ring 110, ⅜ inch thick carbon steel plate 120 (2 inch inner diameter) FIG. 12 may be placed between flange 122 of conduit 100. FIG. 6 and transition ring 110.

Auger 130, FIG. 6, driven by motor M₂ feeds ground coal from conduit 106 after LIBS analysis to downstream NMR analysis subsystem 20. In one example, rod 132 is shown positioned to break up the extrusion in conduit 106 after LIBS analysis. NMR analysis may not require coal in an extruded form.

Vacuum port 134 may be provided in conduit 136 in order to draw dust and particles out of LIBS analysis chamber 138. Chamber 138 may also be purged with an inert gas such as nitrogen.

Valve 140, FIG. 5 can be controlled by a controller, processor, or the like to meter the amount of coal delivered to NMR subsystem 20 from feed auger 130. When valve 140 is closed, coal proceeds to bypass conduit 142 to analysis system exit 144 which can be linked to the coal stream, a bin, or the like. Coal analyzed in NMR subsystem 20 exits NMR subsystem 20 via controllable valve 150 and is fed to exit 144 via conduit 146 with an auger therein driven by motor M₃. The controller, processor, or the like may control motors M₁, M₂, M₃ and valves 140 and/or 150 as well as the operation of LIBS subsystem 22 and NMR subsystem 20.

FIG. 13 shows an example where LIBS subsystem 22 includes 200 MJ laser 160 and spectrometer 162 mounted with respect to chamber 138. The extrusion enters the chamber through an orifice in wall 114 and the analyzed coal exits via fitting 164 and conduit 136. A camera can be used to monitor the extrusion within chamber 138.

Although specific features of the invention are shown in some drawings and not in others, this is for convenience only as each feature may be combined with any or all of the other features in accordance with the invention. The words “including”. “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A coal analysis system comprising:
an extrusion subsystem configured to produce an extrusion from coal samples; and
a spectroscopy subsystem configured to analyze the extrusion.

2. The coal analysis system of claim 1 in which the extrusion subsystem includes:
a centering ring, and
an auger for delivering coal samples through the centering ring producing the extrusion.

3. The coal analysis system of claim 2 in which the extrusion subsystem further includes a sleeve in the spectroscopy subsystem configured to guide the extrusion.

4. The coal analysis system of claim 3 in which the sleeve and the centering ring have the same inner diameter.

5. The coal analysis system of claim 3 in which the sleeve has a cutout for analyzing the extrusion.

6. The coal analysis system of claim 5 in which the sleeve extends at least partially within a conduit.

7. The coal analysis system of claim 6 in which the sleeve terminates in the conduit.

8. The coal analysis system of claim 7 in which the conduit has a larger inner diameter than the sleeve.

9. The coal analysis system of claim 8 in which the sleeve terminates in the conduit proximate an analysis location.

10. The coal analysis system of claim 9 in which the sleeve terminates in the conduit just after the analysis location.

11. The coal analysis system of claim 1 in which the extrusion subsystem configured to produce an extrusion without the use of a binder.

12. The coal analysis system of claim 1 in which the spectroscopy subsystem includes a LIBS analyzer.

13. The coal analysis system of claim 1 further including an NMR analysis subsystem.

14. The coal analysis system of claim 13 in which the NMR analysis subsystem is configured to analyze the extrusion.

15. The coal analysis system of claim 1 in which the NMR analysis subsystem and the spectroscopy subsystem are in-line with each other and the extrusion subsystem.

16. The coal analysis system of claim 13 in which the extrusion is fed from the extrusion subsystem to the spectroscopy subsystem and then to the NMR analysis subsystem.

17. The coal analysis system of claim 13 in which the NMR subsystem is downstream of the spectroscopy subsystem.

18. The coal analysis system of claim 17 further including an auger feeding the coal samples to the NMR subsystem.

19. The coal analysis system of claim 18 further including a member positioned to break up the extrusion after analysis by the spectroscopy subsystem.

20. The coal analysis system of claim 19 further including a valve between the auger and the NMR subsystem for metering the amount of coal sample delivered to the NMR subsystem.

21. The coal analysis system of claim 18 further including an auger feeding coal samples from the NMR subsystem.

22. The coal analysis system of claim 17 further including a coal sample by-pass around the NMR subsystem.

23. A coal analysis system comprising:
an extrusion subsystem configured to produce an extrusion from coal samples, the extrusion subsystem including:
a centering ring, and
an auger for driving coal samples through the centering ring producing the extrusion; and
a LIBS subsystem configured to analyze the extrusion.

24. The coal analysis system of claim 23 further including an NMR analysis subsystem.

25. A coal analysis method comprising:
producing an extrusion from coal samples; and
using spectroscopy to analyze the extrusion.

26. The method of claim 25 in which an auger drives a coal sample through a centering ring to produce the extrusion.

27. The method of claim 25 further including guiding the extrusion in a sleeve within the spectroscopy subsystem.

28. The method of claim 25 in which no binder is used to produce the extrusion.

29. The method of claim 25 in which a plasma is produced from the extruded material.

30. The method of claim 25 further including analyzing the extrusion using an in-line nuclear magnetic resonance subsystem.

31. The method of claim 25 in which the NMR subsystem is downstream of a spectroscopy subsystem.

32. The method of claim 31 further including breaking up the extrusion after analysis.

33. The method of claim 31 further including metering the amount of coal sample delivered to the NMR analysis subsystem.

34. The method of claim 31 further including bypassing the NMR analysis subsystem.
